(19) United States
(12) Patent Application Publication
(10) Pub. No.: US 2022/0295310 A1
(43) Pub. Date: Sep. 15, 2022

(54) MOVING OBJECT

(71) Applicant: HONDA MOTOR CO., LTD., Tokyo (JP)

(72) Inventor: Makoto NAKATSUKA, Tokyo (JP)

(73) Assignee: HONDA MOTOR CO., LTD., Tokyo (JP)

(21) Appl. No.: 17/665,022

(22) Filed: Feb. 4, 2022

(30) Foreign Application Priority Data
Mar. 12, 2021 (JP) 2021-040629

(51) Int. Cl. H04W 24/02; B60W 60/00

(52) U.S. Cl. CPC H04W 24/02; B60W 60/001; B60W 2556/45

(57) ABSTRACT

A moving object capable of automatic movement control includes: a communication unit configured to communicate with a server; and a control unit configured to execute the automatic movement control based on the communication. The control unit changes a method of the automatic movement control in a case where quality of the communication changes during the execution of the automatic movement control.

### CROSS-REFERENCE TO RELATED APPLICATIONS

This application is based on and claims priority under 35 USC 119 from Japanese Patent Application No. 2021-040629, filed on Mar. 12, 2021, the contents of which are incorporated herein by reference.

### TECHNICAL FIELD

The present invention relates to a moving object.

### BACKGROUND ART

There is a vehicle control system configured to perform automatic movement control in which outside information detected by a moving object, such as a vehicle, is transmitted to a server and control instructions are transmitted from the server to the moving object (for example, see JP2018-132985A).

When communication quality deteriorates during execution of advanced automatic movement control that is based on communication with the server, inappropriate automatic movement control that is not based on a latest situation (information) may be performed. Thus, a configuration is conceivable in which the moving object stops the automatic movement control that is based on the communication with the server, for example, when the communication quality deteriorates during the execution of the advanced automatic movement control. However, since temporary deterioration in the communication quality may frequently occur, the automatic movement control that is based on the communication with the server cannot be continuously performed with the configuration in which the automatic movement control is stopped as described above.

JP2018-132985A discloses a vehicle control system in which driver-led control is performed in a communication interruption section in which communication between a communication server and a communication vehicle is interrupted but does not disclose that the automatic movement control that is based on the communication with the server is continuously performed.

### SUMMARY

An object of the present disclosure is to provide a moving object capable of improving continuity of automatic movement control that is based on communication with a server.

According to the present disclosure, a moving object capable of automatic movement control includes:

a communication unit configured to communicate with a server; and

a control unit configured to execute the automatic movement control based on the communication, in which

the control unit changes a method of the automatic movement control in a case where quality of the communication changes during the execution of the automatic movement control.

According to the moving object of the present disclosure, continuity of automatic movement control that is based on communication with a server can be improved.

### BRIEF DESCRIPTION OF DRAWINGS

Exemplary embodiments of the present disclosure will be described in detail based on the following figures, wherein:

FIG. 1 shows a vehicle communication system including a vehicle (moving object) according to the present embodiment;

FIG. 2 is a block diagram showing a configuration of a vehicle system mounted on the vehicle according to the present embodiment;

FIG. 3 shows an example of a wireless communication area covered by a base station; and

FIG. 4 is a flowchart of an example of automatic movement under automatic movement control of the vehicle.

### DESCRIPTION OF EMBODIMENTS

In the following, an embodiment of a moving object according to the present disclosure will be described with reference to the drawings. An example in which a vehicle M, such as an automobile, is used as a moving object according to the present disclosure will be described.

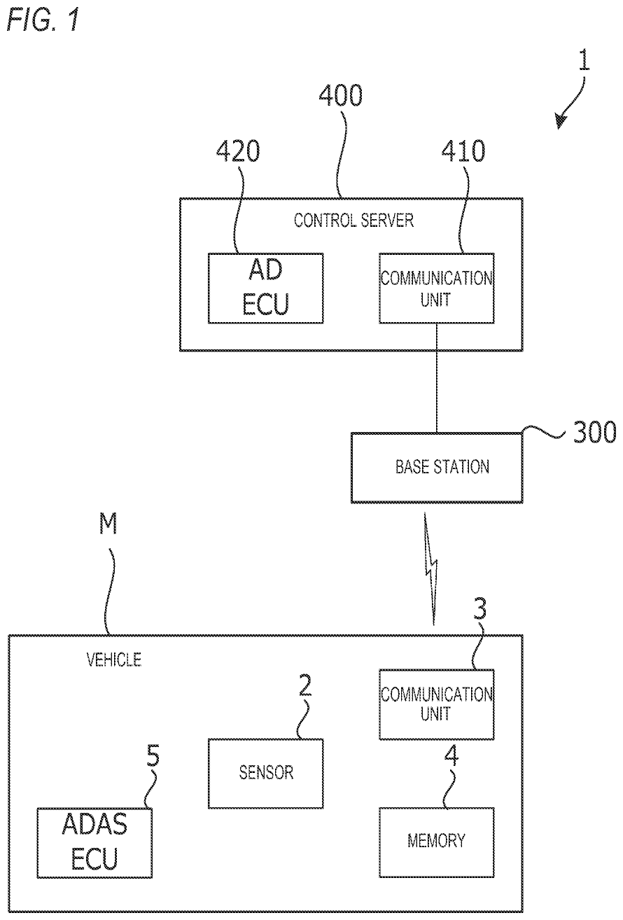

First, a vehicle communication system 1 including the vehicle M of the present embodiment will be described with reference to FIG. 1. As shown in FIG. 1, the vehicle communication system 1 includes: the vehicle M; and base stations 300 and a control server 400 that are communicably connected to the vehicle M.

The vehicle M includes: a sensor 2 configured to acquire outside information around the vehicle M, and a communication unit 3 for communicating with the base stations 300. The vehicle M further includes: a memory 4 for storing vehicle information (including the outside information acquired by the sensor 2) about the vehicle M; and an advanced driver-assistance systems electronic control unit (ADAS ECU) 5 configured to manage operation of the vehicle M.

The base stations 300 are installed at predetermined intervals to realize widespread communication with the vehicle M. Each of the base stations 300 includes antennae. Each of the antennae may have different performance. The base stations 300 are wirelessly connected to the vehicle M to communicate with the vehicle M.

The control server 400 includes: a communication unit 410; and an automated driving electronic control unit (AD ECU) 420. The control server 400 is installed, for example, in a facility, such as a management station. The communication unit 410 is communicably connected to the base stations 300 via a wired or wireless communication network. In addition, the communication unit 410 is communicably connected to the vehicle M via the base stations 300. The AD ECU 420 is configured to determine a control method of automatic movement performed by the vehicle M based on the vehicle information about the vehicle M transmitted from the vehicle M via the base stations 300. The AD ECU 420 is configured to transmit control contents of the automatic movement in the determined control method of the vehicle M to the vehicle M via the base stations 300.

The vehicle M is configured to perform the automatic movement under the automatic movement control that is based on the communication with the control server 400. The vehicle M performs the automatic movement under the automatic movement control based on the control contents of the automatic movement transmitted from the control server 400. The vehicle M is configured to execute the control contents of the automatic movement control, for example, by the ADAS ECU 5. In addition, the vehicle M can also perform support movement under support movement control by the ADAS ECU 5. A control device that executes the control contents transmitted from the control server 400 may be a predetermined vehicle control unit provided in the vehicle M separately from the ADAS ECU 5.

The control method of the automatic movement transmitted from the control server 400 is one of a plurality of methods (for example, a first automatic movement control method, a second automatic movement control method, and a third automatic movement control method). The first automatic movement control method, the second automatic movement control method, and the third automatic movement control method are driving methods descendingly ordered by degree of automation in vehicle control. High degree of automation means that, for example, a degree is low to which the vehicle is controlled based on driver's (user's) operation onto the vehicle M, that is, the number of tasks, such as monitoring surroundings of the vehicle M, required to be performed by the driver is small.

The first automatic movement control method is, for example, an automatic movement control method in which the driver does not need to monitor the surroundings of the vehicle M or to operate a steering wheel. The first automatic movement control method is, for example, a control method in which the vehicle M can automatically control a speed and steering with the driver not handling (for example, neither gripping, holding, nor touching) the steering wheel and not monitoring the surroundings of the vehicle.

The second automatic movement control method is, for example, an automatic movement control method in which the driver needs to monitor the surroundings of the vehicle M but the driver does not need to operate the steering wheel. The second automatic movement control method is, for example, a control method in which the vehicle M can automatically control a speed and the steering with the driver monitoring the surroundings of the vehicle M but not operating the steering wheel.

The third automatic movement control method is, for example, an automatic movement control method in which the driver needs, at least, to monitor the surroundings (to look forward) for safe driving. The third automatic movement control method is, for example, a control method in which the vehicle M can automatically control a speed and the steering with the driver operating the steering wheel and monitoring the surroundings of the vehicle M.

In the third automatic movement control method, the driver may perform manual driving or ADAS may be activated. ADAS are represented by an adaptive cruise control system (ACC) or a lane keeping assist system (LKAS).

The above conditions under which the control of the first to third automatic movement control methods is performed are examples and may be modified arbitrarily as long as the first automatic movement control method, the second automatic movement control method, and the third automatic movement control method constitute descending order by degree of automation in the vehicle M. For example, some or all of the first to third automatic movement control methods may relate to automated driving or driving support instead. Further, the present embodiment may be applied to two or more control methods instead of the three control methods.

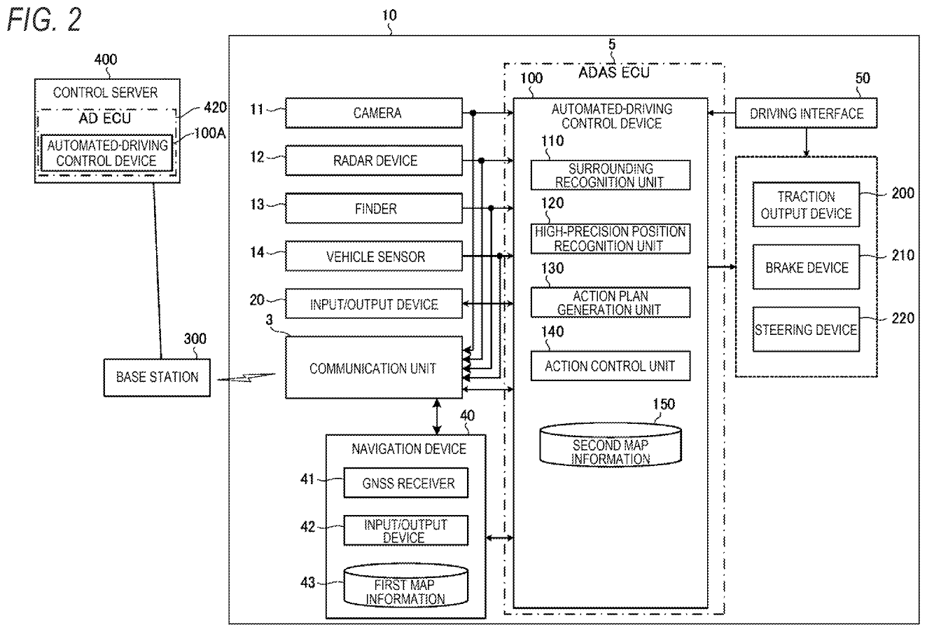

Next, a vehicle system 10 mounted on the vehicle M will be described with reference to FIG. 2. As shown in FIG. 2, the vehicle system 10 includes: a camera 11; a radar device 12; a finder 13; a vehicle sensor 14; an input/output device 20; the communication unit 3; a navigation device 40; a driving interface 50; an automated-driving control device 100; a traction output device 200; a brake device 210; and a steering device 220. These devices are communicably connected to each other via a wired or wireless communication network. The communication network connecting these devices is, for example, a controller area network (CAN).

The camera 11, the radar device 12, the finder 13, and the vehicle sensor 14 are included in the sensor 2 shown in FIG. 1. The camera 11, the radar device 12, the finder 13, and the vehicle sensor 14 is configured to acquire the outside information around the vehicle M.

The camera 11 is a digital camera configured to shoot the surroundings (for example, a region in front) of the vehicle M to output obtained image data to the automated-driving control device 100 and the communication unit 3. The radar device 12 uses, for example, a millimeter wave to acquire a position of an object around (for example, in front of, behind, and on sides of) the vehicle M and outputs an obtained result to the automated-driving control device 100 and the communication unit 3. The finder 13 is, for example, a laser imaging detection and ranging (LIDAR) configured to measure a distance to the object (target) around (for example, in front of, behind, and on the sides of) the vehicle M using predetermined laser light and to output an obtained result to the automated-driving control device 100 and the communication unit 3.

The vehicle sensor 14 includes, for example: a vehicle speed sensor configured to measure a speed of the vehicle M; an accelerometer configured to measure acceleration of the vehicle M; a gyroscope configured to measure angular velocity around a vertical axis of the vehicle M; an orientation sensor configured to detect an orientation of the vehicle M; and the like. The vehicle sensor 14 further includes an electromagnetic-wave strength indicator configured to measure strength of the electromagnetic wave (that is, communication conditions) used by the communication unit 3 for the communication. The vehicle sensor 14 is configured to output an obtained result of each of the sensors to the automated-driving control device 100 and the communication unit 3.

The input/output device 20 includes: an output device configured to provide various types of information for the user of the vehicle M (hereinafter, also simply referred to as the user); and an input device configured to receive various types of input operation from the user. In the present embodiment, the user is not limited to a person who manages or owns and uses the vehicle M. For example, the user may be a person who uses the vehicle M instead of the person who manages or owns the vehicle M.

The output device of the input/output device 20 is, for example, a display configured to display a processing result of the automated-driving control device 100 and an automated-driving control device 100A (to be described later) of the control server 400. The output device may be a speaker, a buzzer, an indicator, or the like. The input device of the input/output device 20 is, for example, a touch panel or a button (a key, a switch, or the like) configured to output an operation signal corresponding to input operation received from the user to the automated-driving control device 100 and the automated-driving control device 100A of the control server 400.

The navigation device 40 includes: a global navigation satellite system (GNSS) receiver 41; and an input/output device 42. The navigation device 40 further includes a storage device (not shown), such as a hard disk drive (hereinafter, also referred to as an HDD) and a flash memory, in which first map information 43 is stored. The first map information 43 is, for example, information indicating a road shape by a link representing a road and nodes connected by the link. Further, the first map information 43 may include information indicating a curvature of a road or a point of interest (PO).

The GNSS receiver 41 determines, based on a signal received from a GNSS satellite, a latitude and longitude of the vehicle M. Further, the navigation device 40 may determine or correct a location of the vehicle M by an inertial navigation system (INS) using an output of the vehicle sensor 14.

The input/output device 42 includes: an output device configured to provide various types of information for the user; and an input device configured to receive various types of input operation from the user. The output device of the input/output device 42 is, for example, a display configured to display a processing result (for example, a map route to be described later) of the navigation device 40. The input device of the input/output device 42 is, for example, a touch panel or a button (a key, a switch, or the like) configured to output an operation signal corresponding to input operation received from the user to the navigation device 40. The input/output device 42 and the input/output device 20 may be configured with the same device.

The navigation device 40 is configured to determine, by referring to the first map information 43, a route (hereinafter, also referred to as a map route), for example, from the position of the vehicle M acquired by the GNSS receiver 41 to a destination input by the user. The navigation device 40 guides the user along the determined map route using the input/output device 42. The navigation device 40 is configured to output information indicating the acquired position of the vehicle M and the determined map route to the automated-driving control device 100 and the communication unit 3.

The driving interface 50 includes various devices such as an accelerator pedal, a brake pedal, a gear shift, a steering wheel, an irregular steering wheel, and a joystick. The driving interface 50 is provided with a sensor configured to detect how much the driving interface 50 is being operated or whether the driving operator 50 is being operated. A detection result by the sensor of the driving interface 50 is output to some or all of the automated-driving control device 100, the communication unit 3, the traction output device 200, the brake device 210, and the steering device 220.

The traction output device 200 is configured to output traction (torque) to drive wheels for the vehicle M to travel. The traction output device 200 includes, for example; an electric motor; and an electric motor electric control unit (ECU) configured to control the electric motor. The electric motor ECU is configured to control the electric motor based on the detection result of the sensor of the driving interface 50 (for example, the accelerator pedal), control information from the automated-driving control device 100, and control information from the automated-driving control device 100A of the control server 400. If the vehicle M includes an internal combustion engine as a drive source and a transmission, the traction output device 200 may include: the internal combustion engine; the transmission; and an ECU configured to control the internal combustion engine and the transmission.

The brake device 210 includes, for example: a brake caliper; a cylinder for transmitting hydraulic pressure to the brake caliper; an electric motor configured to generate the hydraulic pressure in the cylinder; and a brake ECU. The brake ECU is configured to control the electric motor of the brake device 210 based on the detection result of the sensor of the driving interface 50 (for example, the brake pedal), the control information from the automated-driving control device 100, and the control information from the automated-driving control device 100A of the control server 400 such that brake torque is output to each wheel based on brake operation.

The steering device 220 includes, for example: a steering ECU; and an electric motor. The electric motor of the steering device 220 is configured to change a direction of the steered wheels by applying a force to, for example, a rack-and-pinion mechanism. The steering ECU is configured to drive the electric motor of the steering device 220 to change the direction (that is, a steering angle) of the steered wheels based on the detection result of the sensor of the driving interface 50 (for example, the steering wheel), the control information from the automated-driving control device 100, and the control information from the automated-driving control device 100A of the control server 400.

The communication unit 3 is configured to communicate with the base stations 300 wirelessly. The communication unit 3 is configured to communicate with the communication unit 410 of the control server 400 via the base stations 300. The communication unit 3 is configured to transmit the vehicle information including: the outside information around the vehicle M acquired by the camera 11, the radar device 12, the finder 13, and the vehicle sensor 14; position information and route information determined by the navigation device 40; operation information detected by the driving interface 50; and the like to the control server 400 via the base stations 300. The communication unit 3 may be configured with, for example, a telematic control unit (TCU) configured to perform bidirectional communication. In addition, the communication unit 3 may use, for example, a cellular network, a Wi-Fi (registered trademark) network, Bluetooth (registered trademark), dedicated short-range communications (DSRC), or the like.

The automated-driving control device 100 includes: a surrounding recognition unit 110; a high-precision position recognition unit 120; an action plan generation unit 130; and an action control unit 140. The automated-driving control device 100 further includes a storage device (not shown) configured with a flash memory that can be accessed by each of the functional units (for example, the high-precision position recognition unit 120) of the automated-driving control device 100. Second map information 150 is stored in the storage device. The storage device may be the memory 4 shown in FIG. 1.

The surrounding recognition unit 110 is configured to perform sensor fusion processing on information acquired by some or all of the camera 11, the radar device 12, and the finder 13 to recognize an object around the vehicle M and to acquire the position of the object. The surrounding recognition unit 110 is configured to recognize, for example, an obstacle, a road shape, a traffic light, a guardrail, a utility pole, a surrounding vehicle (including a travelling state, such as a speed and acceleration, or a parking state), a lane marking, a pedestrian, and the like and to recognize positions thereof.

The high-precision position recognition unit 120 is configured to recognize the detailed position and a detailed orientation of the vehicle M by referring to the position of the vehicle M acquired by the navigation device 40, the detection result of the vehicle sensor 14, the image acquired by the camera 11, the second map information 150, and the like. For example, the high-precision position recognition unit 120 is configured to recognize a lane along which the vehicle M is travelling or a relative position and a relative orientation of the vehicle M with respect to the lane.

The action plan generation unit 130 is configured to generate an action plan of the vehicle M. Specifically, the action plan generation unit 130 is configured to generate a target trajectory along which the vehicle M will travel as the action plan of the vehicle M. The target trajectory is, for example, information expressed by points (trajectory points) to be arrived by the vehicle M arranged at an interval of a predetermined distance (for example, several meters). The target trajectory may include information about a speed, such as a target speed or target acceleration of the vehicle M for each predetermined time or for each trajectory point.

The action control unit 140 is configured to control the vehicle M such that the vehicle M acts in accordance with the action plan generated by the action plan generation unit 130. Specifically, the action control unit 140 is configured to control the traction output device 200, the brake device 210, and the steering device 220 such that the vehicle M travels along the target trajectory generated by the action plan generation unit 130 on time. For example, the action control unit 140 is configured to control the traction output device 200 and the brake device 210 based on the information about a speed associated with the target trajectory and to control the steering device 220 based on a curvature of the target trajectory.

The second map information 150 is precise more highly than the first map information 43. The second map information 150 includes, for example, information indicating a center of a lane, a boundary line (for example, a road partition line) of a lane, and the like. The second map information 150 may further include: road information; traffic restriction information; address information; facility information; telephone number information; and the like. The second map information 150 may be updated at any time. The second map information 150 may be updated based on, for example, the information acquired by some or all of the camera 11, the radar device 12, and the finder 13.

The automated-driving control device 100 is configured with the ADAS ECU 5. Each function of the automated-driving control device 100 is executed by the ADAS ECU 5. Each of the functional units of the automated-driving control device 100 is implemented by, for example, a central processing unit (CPU) executing a predetermined program (software). Some or all of the functional units of the automated-driving control device 100 may be implemented by hardware, such as a large-scale integration (LSI), an application-specific integrated circuit (ASIC), a field-programmable gate array (FPGA), and a graphics processing unit (GPU). For example, the high-precision position recognition unit 120 and the storage device storing the second map information 150 may be implemented by a map positioning unit (MPU). Some or all of the functional units included in the automated-driving control device 100 may be implemented by combination of software and hardware.

Next, the AD ECU 420 of the control server 400 will be described with reference to FIG. 2. As shown in FIG. 2, the AD ECU 420 includes the automated-driving control device 100A. The automated-driving control device 100A has a configuration and a function similar to those of the automated-driving control device 100 in the vehicle system 10 of the vehicle M. Each function of the automated-driving control device 100A is executed by the AD ECU 420. The AD ECU 420 is configured to determine the control method of the automatic movement performed by the vehicle M based on the vehicle information about the vehicle M transmitted from the vehicle M as described above and to transmit the control contents of the automatic movement of the vehicle M in the determined control method to the vehicle M.

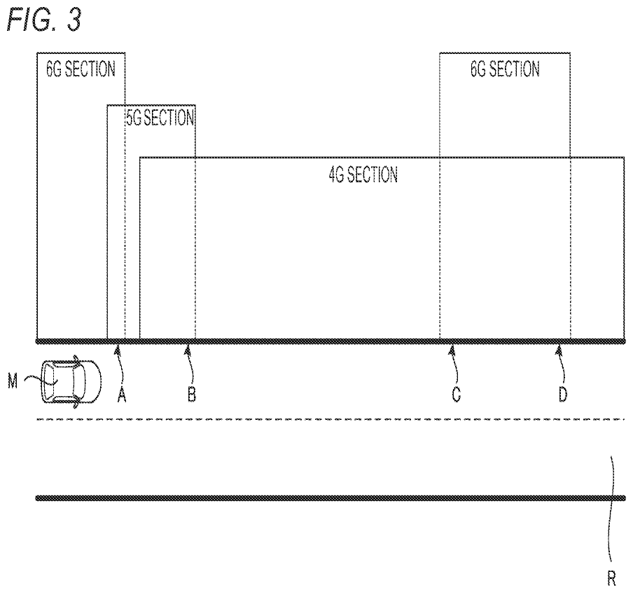

Next, an example of the communication performed between the vehicle M and the base stations 300 will be described with reference to FIG. 3.

The base stations 300 configured to communicate with the vehicle M wirelessly are installed at the predetermined intervals in various places in which the vehicle M travels. A method of wireless communication is, for example, a communication method that is used by a mobile phone, a smartphone, or the like and that permits a relatively wide range of movement. The method of the wireless communication is, for example, a third generation mobile communication standard (hereinafter referred to as “3G”), a fourth generation mobile communication standard (hereinafter referred to as “4G”), a fifth generation mobile communication standard (hereinafter referred to as “5G”), and a sixth generation mobile communication standard (hereinafter referred to as “6G”). The mobile communication standards enable high-speed communication as the generation advances, that is, as the number increases from “3G” to “6G”. Various base stations 300 corresponding to electromagnetic waves of 3G to 6G are installed in each of the places in which the vehicle M travels.

FIG. 3 is a diagram showing an example of various wireless communication areas (4G to 6G sections) covered by the base stations 300 on a road on which the vehicle M travels. As shown in FIG. 3, at least adjacent areas of the 4G to 6G sections overlap with each other in order not to generate an area in which the communication cannot be performed. In this example, each wireless communication area has a rectangular shape for the sake of convenience.

Based on the communication conditions detected by the electromagnetic-wave strength indicator (vehicle sensor 14), that is, strength of an electromagnetic wave that can be received, the vehicle M is configured to designate one of the base stations 300 (for example, a 3G base station, a 4G base station, a 5G base station, or a 6G base station) as a partner with which the communication unit 3 of the vehicle M communicates. The one of the base stations 300, which is the communication partner, changes according to a location of the vehicle M. For example, the vehicle M constantly measures strength of an electromagnetic wave of a neighboring base station 300 and, when strength of the electromagnetic wave becomes equal to or less than a certain value, severs the communication with the base station 300 to switch to another base station 300 whose electromagnetic wave has greater strength.

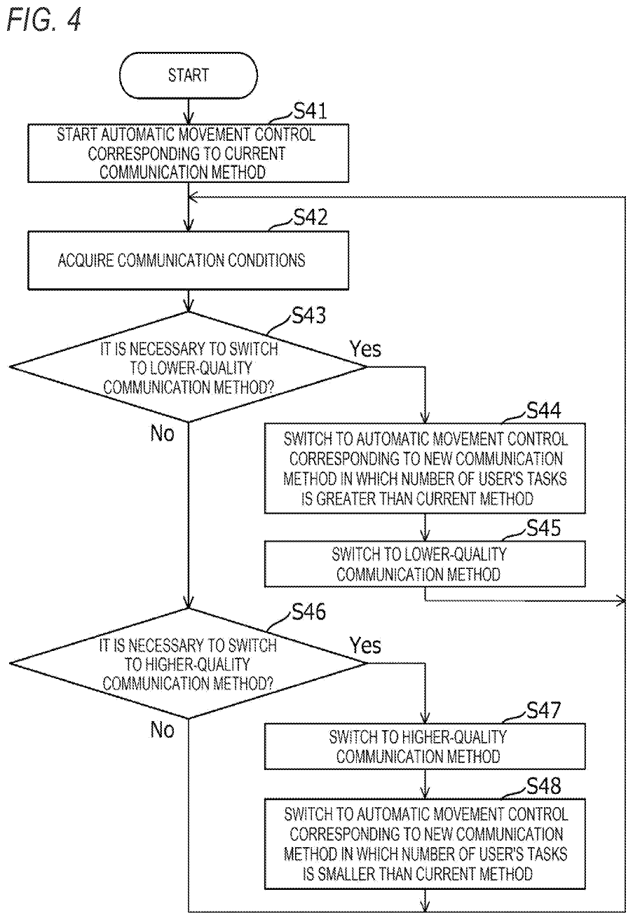

Next, an example of the automatic movement under the automatic movement control of the vehicle M will be described with reference to FIGS. 3 and 4.

First, when an ignition switch is pushed and an engine is started, the vehicle M acquires the surrounding communication conditions by the electromagnetic-wave strength indicator (the vehicle sensor 14). The vehicle M determines a wireless communication method (in the present example, 3G to 6G) of an electromagnetic wave that can be received most strongly (or whose strength is more than a predetermined value) out of detected electromagnetic waves to set the determined wireless communication method as an engaged communication method.

The vehicle M informs the control server 400 of the set engaged communication method via one of the base stations 300 that is the current communication partner. For example, in FIG. 3, when the engine of the vehicle M is started, the vehicle M can receive an electromagnetic wave of 6G most strongly. Therefore, the vehicle M sets “6G” as the wireless communication method and informs the control server 400 of “6G” as the engaged communication method via the base station 300 of 6G.

The control server 400 determines the control method of the automatic movement performed by the vehicle M based on the communication method informed by the vehicle M. For example, in FIG. 3, since the control server 400 is informed of “6G” as the engaged communication method by the vehicle M, the control server 400 selects the first automatic movement control method, in which the number of the driver's tasks is the smallest, for the control method of the automatic movement corresponding to “6G”. As described above, with “6G” highest-speed communication can be performed with small communication delay out of 3G to 6G. Therefore, when “6G” communication is performed with a high-quality electromagnetic wave, the control server 400 selects the first automatic movement control method, in which the number of the driver's tasks is the smallest, that is, the driver does not need to monitor the surroundings of the vehicle M or to operate the steering wheel for the control method of the automatic movement performed by the vehicle M.

The control server 400 receives the vehicle information about the vehicle M from the vehicle M via the base station 300 of 6G and determines the control contents of the automatic movement of the vehicle M in the selected first automatic movement control method based on the received vehicle information about the vehicle M. The control server 400 transmits the determined control contents of the automatic movement of the vehicle M to the vehicle M via the base station 300 of 6G.

The vehicle M starts moving under the automatic movement control of the first automatic movement control method corresponding to the current communication method of 6G based on the control contents of the automatic movement transmitted from the control server 400 (step S41).

Next, the vehicle M acquires the communication conditions around the vehicle M during the movement by the electromagnetic-wave strength indicator (step S42).

Based on the communication conditions acquired in step S42, the vehicle M determines whether it is necessary to change the current communication method of the vehicle M to a lower-quality method (step S43).

In step S43, if the vehicle M determines that it is necessary to switch to a lower-quality communication method (YES in step S43), the vehicle M informs the control server 400 of the lower-quality communication method as the engaged communication method.

For example, in FIG. 3, the vehicle M has traveled on a road R to a point A. The point A is a wireless communication area in which the 6G section and the 5G section overlap with each other. Thus, the vehicle M can receive electromagnetic waves of 6G and 5G for the communication. Therefore, the vehicle M determines, for example, a communication method whose electromagnetic wave can be received most strongly (or has strength more than a predetermined value). The point A is an inner area of the 6G section and is an inner area of the 5G section. Therefore, the vehicle M can receive the electromagnetic wave of 5G as the strongest electromagnetic wave at the point A. The vehicle M selects “5G” for the wireless communication method. Therefore, when the vehicle M has traveled to the point A, the vehicle M needs to change the current communication method of the vehicle M to “5G,” whose electromagnetic wave has lower quality than “6G.” The vehicle M then informs the control server 400 of “5G” as the engaged communication method via the base station 300 that is the current communication partner.

The control server 400 determines the control method of the automatic movement performed by the vehicle M based on the engaged communication method informed by the vehicle M. For example, at the point A in FIG. 3, since the control server 400 is informed of “5G” as the engaged communication method by the vehicle M, the control server 400 selects the second automatic movement control method, in which the number of the driver's task is greater than the first automatic movement control method for the control method of the automatic movement corresponding to 5G. “5G” enables the second highest-speed communication out of 3G to 6G. Therefore, when the “5G” communication is performed, the control server 400 selects the second automatic movement control method, in which the driver needs to monitor the surroundings of the vehicle M but does not need to operate the steering wheel, for the control method of the automatic movement performed by the vehicle M.

The control server 400 receives the vehicle information about the vehicle M from the vehicle M via the base station 300 and determines the control contents of the automatic movement of the vehicle M in the selected second automatic movement control method based on the received vehicle information about the vehicle M. The control server 400 transmits the determined control contents of the automatic movement of the vehicle M to the vehicle M via the base station 300.

If the vehicle M determines in step S43 that it is necessary to change the current communication method of the vehicle M to a lower-quality communication method (YES in step S43) and the vehicle M receives the control contents of the automatic movement of the vehicle M from the control server 400, the vehicle M first changes the current control method of the automatic movement to the second automatic movement control method corresponding to 5G, which is the new wireless communication method, that is, the second automatic movement control method, in which the number of the driver's tasks is greater than the first automatic movement control method, while the vehicle M is in the wireless communication area (the point A of the present example) in which electromagnetic waves of 5G and 6G can be received (step S44).

Next, the vehicle M changes the current wireless communication method used in the communication with the base station 300, that is, “6G” to “5G” (step S45).

After the switching of the wireless communication method used in the communication with the base station 300, the vehicle M starts moving under the automatic movement control of the second automatic movement control method corresponding to the current communication method of 5G based on the control contents of the automatic movement of the vehicle M received from the control server 400 and returns to step S42 to repeat the steps.

On the other hand, if the vehicle M determines in step S43 that it is not necessary to switch to a lower-quality communication method (NO in step S43), the vehicle M determines whether it is necessary to change the current wireless communication method to a higher-quality communication method (step S46).

In step S46, if the vehicle M determines that it is necessary to switch to a higher-quality communication method (YES in step S46), the vehicle M informs the control server 400 of the determined higher-quality communication method as the engaged communication method.

For example, in FIG. 3, the vehicle M has traveled on a road R to a point C. The point C is a wireless communication area in which the 4G section and the 6G section overlap with each other. Thus, the vehicle M can receive electromagnetic waves of 4G and 6G. Therefore, the vehicle M determines, for example, an electromagnetic wave that can be received whose strength is more than a predetermined value (or greatest). For example, strength of both electromagnetic waves of 4G 6G that can be received is more than the predetermined value at the point C. In this case, the vehicle M selects “6G,” in which quality of the electromagnetic wave is higher than “4G.” Therefore, when the vehicle M has traveled to the point C, the vehicle M needs to change the current communication method of the vehicle M to “6G.” whose electromagnetic wave has higher quality than “4G.” The vehicle M then informs the control server 400 of “6G” as the engaged communication method via the base station 300 that is the current communication partner.

The control server 400 determines the control method of the automatic movement performed by the vehicle M based on the engaged communication method informed by the vehicle M. For example, at the point C in FIG. 3, since the control server 400 is informed of “6G” as the engaged communication method by the vehicle M, the control server 400 selects the first automatic movement control method, in which the number of the driver's tasks is the smallest, that is, the driver does not need to monitor the surroundings of the vehicle M or to operate the steering wheel, for the control method of the automatic movement corresponding 6G.

The control server 400 receives the vehicle information about the vehicle M from the vehicle M via the base station 300 and determines the control contents of the automatic movement of the vehicle M in the selected first automatic movement control method based on the received vehicle information about the vehicle M. The control server 400 transmits the determined control contents of the automatic movement of the vehicle M to the vehicle M via the base station 300 of 6G.

If the vehicle M determines in step S46 that it is necessary to change the current communication method of the vehicle M to a higher-quality communication method (YES in step S46) and the vehicle M receives the control contents of the automatic movement of the vehicle M from the control server 400, the vehicle M first changes the current wireless communication method in which the communication is performed with the base station 300, that is, from “4G” to “6G” (step S47).

Next, the vehicle M changes the current control method of the automatic movement of the vehicle M to the first automatic movement control method corresponding to 6G, which is the new wireless communication method, that is, the first automatic movement control method, in which the number of the driver's tasks is the smallest (step S48).

After the switching of the control method of the automatic movement of the vehicle M, the vehicle M starts moving under the automatic movement control of the first automatic movement control method corresponding to the current communication method of 6G based on the control contents of the automatic movement of the vehicle M received from the control server 400 and returns to step S42 to repeat the steps.

On the other hand, if the vehicle M determines in step S46 that it is not necessary to switch to a higher-quality communication method (NO in step S46), the vehicle M maintains the current communication method of the vehicle M and returns to step S42 to repeat the steps.

In FIG. 3, for example, also when the vehicle M has traveled to a point B in which the 5G section and the 4G section overlap with each other, similar processing when the vehicle M has traveled to the point A described above is performed, and the vehicle M starts moving under the automatic movement control of the third automatic movement control method corresponding to the current communication method of 4G. As described above, in the third automatic movement control method, the driver needs, at least, to monitor the surroundings (to look forward) for safe driving and the number of the driver's tasks is greater than the second automatic movement control method. For example, also when the vehicle M has traveled to a point D in which the 6G section and the 4G section overlap with each other, similar processing when the vehicle M has traveled to the point A described above is performed, and the vehicle M starts moving under the automatic movement control of the third automatic movement control method corresponding to the current communication method of 4G.

Although quality of an electromagnetic wave changes as a communication delay changes by the switching of the wireless communication method from “3G” to “6G” in the example of the present embodiment, the present invention is not limited thereto. For example, the quality of an electromagnetic wave may change as the communication delay changes by switching modes within one of the standards of “3G” to “6G.” In addition, for example, the quality of an electromagnetic wave may change as the communication delay changes by fluctuation in strength of the electromagnetic wave between the vehicle M and the base station 300 (control server 400) due to an obstacle or the like or by change in congestion conditions of the control server 400 or the like. Then, when the quality of an electromagnetic wave changes due to these factors, the current method of the automatic movement control of the vehicle M may be changed.

As described above, according to the vehicle M, the current automatic movement control method of the vehicle M can be changed when the quality (the wireless communication methods of 3G to 6G) of an electromagnetic wave used for the automatic movement control of the vehicle M changes. Therefore, even when communication conditions deteriorates as the vehicle M moves, the automatic movement control of the vehicle M that is based on the communication between the vehicle M and the control server 400 can be continued by the switching to the automatic movement control of the method according to the deteriorated communication quality. Therefore, continuity of the automatic movement control of the vehicle M that is based on the communication with the control server 400 can be improved.

According to the vehicle M, when communication conditions deteriorates as the vehicle M moves, it is possible to switch to the automatic movement control of the method in which the number of the driver's tasks increases, that is, a degree of dependence on the communication between the vehicle M and the control server 400 decreases (a degree of automation decreases). Therefore, inappropriate automatic movement control entailed by the deterioration of the quality of an electromagnetic wave, that is, disagreement between the wireless communication method and the automatic movement control method can be prevented, and continuity of the automatic movement control that is based on the communication between the vehicle M and the control server 400 can be improved.

According to the vehicle M, when communication conditions changes during the movement and the communication quality deteriorates, the current control method of the automatic movement can be changed to that in which the number of the driver's tasks increases before the current wireless communication method of the vehicle M is changed to that whose electromagnetic wave has lower quality. Therefore, it is possible to prevent inappropriate control such that the automatic movement control of a method in which the number of the driver's tasks is smaller, that is, the degree of dependence on the communication between the vehicle M and the control server 400 is higher (the degree of automation is higher) is performed based on a lower-quality communication method.

According to the vehicle M, when the communication conditions changes as the vehicle M moves and the communication quality is improved, by switching to an automatic movement control in which the number of the driver's tasks decreases, that is, the degree of dependence on the communication between the vehicle M and the control server 400 increases (the degree of automation increases), an automatic movement control in which the number of the driver's tasks decreases can be performed.

According to the vehicle M, when communication conditions changes and the communication quality is improved during the movement, the current control method of the automatic movement can be changed to a control method in which the number of the driver's tasks decreases after the current wireless communication method of the vehicle M is changed to that whose electromagnetic wave has higher quality. Therefore, it is possible to prevent inappropriate control such that an automatic movement control of the method in which the number of the driver's tasks decreases, that is, the degree of dependence on the communication between the vehicle M and the control server 400 increases (the degree of automation increases) is performed based on a lower-quality communication method.

Although the embodiment of the present disclosure has been described above, the present invention is not limited to the above embodiment. Modifications, improvements, and the like can be made as appropriate.

Although the moving object is the vehicle in the above embodiment, the present invention is not limited thereto. The concept of the present disclosure can be applied not only to a vehicle but also to a robot, a ship, an aircraft, and the like that are provided with a drive source and are movable by power of the drive source.

At least the following are described in the present disclosure. Although corresponding components or the like in the above embodiment are shown in parentheses, the present invention is not limited thereto.

(1) A moving object (vehicle M) capable of automatic movement control includes:

a communication unit (communication unit 3) configured to communicate with a server (control server 400); and

a control unit (ADAS ECU 5) configured to execute the automatic movement control based on the communication, in which

the control unit changes a method of the automatic movement control in a case where quality (wireless communication methods 3G to 6G) of the communication changes during the execution of the automatic movement control.

According to (1), by changing the method of the automatic movement control of the moving object even in a case where the quality of the communication for the automatic movement control deteriorates, it is possible to shift to the automatic movement control of the method according to the deteriorated communication quality to continue the automatic movement control, which is based on the communication between the moving object and the server. Therefore, continuity of the automatic movement control, which is based on the communication with the server, can be improved.

(2) The moving object according to (1), in which

the control unit changes the method of the automatic movement control to a method in which the number of tasks of a user of the moving object is greater than the current method of the automatic movement control (for example, from the first automatic movement control method to the second automatic movement control method) in a case where the quality of the communication deteriorates (for example, from “6G” to “5G”).

According to (2), in a case where the quality of the communication deteriorates during the movement, by the switching to the method in which the number of the user's tasks is greater than the current method, that is, degree of dependence on the communication between the moving object and the server is smaller than the current method, an inappropriate automatic movement control entailed by the deterioration in the quality of the communication is prevented, and the automatic movement control, which is based on the communication between the moving object and the server, can be continued. Therefore, the continuity of the automatic movement control, which is based on the communication with the server, can be improved.

(3) The moving object according to (2), in which

the deterioration in the quality of the communication is due to change of a method of the communication, and

the control unit changes the method of the automatic movement control to the method in which the number of the user's tasks is greater than the current method of the automatic movement control (from the first automatic movement control method to the second automatic movement control method) before the control unit changes the methods of the communication entailed by the deterioration in the quality of the communication (from “6G” to “5G”).

According to (3), it is possible to prevent the automatic movement control in the method in which the number of the user's tasks is small, that is, the degree of dependence on the communication between the moving object and the server is high from being executed based on the low-quality communication.

(4) The moving object according to any one of (1) to (3), in which

the control unit changes the method of the automatic movement control to a method in which the number of the user's tasks is smaller than the current method of the automatic movement control (for example, from the third automatic movement control method to the first automatic movement control method) in a case where the quality of the communication increases (for example, from “4G” to “6G”).

According to (4), in a case where the quality of communication is improved during the movement, the automatic movement control in which the number of the user's tasks is smaller than the current method can be executed by the switching to the method of the automatic movement control in which the number of the user's tasks is smaller than the current method, that is, the degree of dependence on the communication between the moving object and the server is greater than the current method.

(5) The moving object according to (4), in which

the increase in the quality of the communication is due to change of the method of the communication, and

the control unit changes the method of the automatic movement control to the method in which the number of the user's tasks is smaller than the current method of the automatic movement control (from the third automatic movement control method to the first automatic movement control method) after the control unit changes the methods of the communication entailed by the increase in the quality of the communication (from “4G” to “6G”).

According to (5), it is possible to prevent the automatic movement control in the method in which the number of the user's tasks is small, that is, the degree of dependence on the communication between the moving object and the server is high from being executed based on the low-quality communication.

What is claimed is:

1. A moving object capable of automatic movement control comprising:
a communication unit configured to communicate with a server; and
a control unit configured to execute the automatic movement control based on the communication, wherein
the control unit changes a method of the automatic movement control in a case where quality of the communication changes during the execution of the automatic movement control.

2. The moving object according to claim 1, wherein
the control unit changes the method of the automatic movement control to a method in which the number of tasks of a user of the moving object is greater than the current method of the automatic movement control in a case where the quality of the communication deteriorates.

3. The moving object according to claim 2, wherein
the deterioration in the quality of the communication is due to change of a method of the communication, and
the control unit changes the method of the automatic movement control to the method in which the number of the user's tasks is greater than the current method of the automatic movement control before the control unit changes the methods of the communication entailed by the deterioration in the quality of the communication.

4. The moving object according to claim 1, wherein
the control unit changes the method of the automatic movement control to a method in which the number of the user's tasks is smaller than the current method of the automatic movement control in a case where the quality of the communication increases.

5. The moving object according to claim 2, wherein
the control unit changes the method of the automatic movement control to a method in which the number of the user's tasks is smaller than the current method of the automatic movement control in a case where the quality of the communication increases.

6. The moving object according to claim 3, wherein
the control unit changes the method of the automatic movement control to a method in which the number of the user's tasks is smaller than the current method of the automatic movement control in a case where the quality of the communication increases.

7. The moving object according to claim 4, wherein
the increase in the quality of the communication is due to change of the method of the communication, and
the control unit changes the method of the automatic movement control to the method in which the number of the user's tasks is smaller than the current method of the automatic movement control after the control unit changes the methods of the communication entailed by the increase in the quality of the communication.

8. The moving object according to claim 5, wherein
the increase in the quality of the communication is due to change of the method of the communication, and
the control unit changes the method of the automatic movement control to the method in which the number of the user's tasks is smaller than the current method of the automatic movement control after the control unit changes the methods of the communication entailed by the increase in the quality of the communication.

9. The moving object according to claim 6, wherein
the increase in the quality of the communication is due to change of the method of the communication, and
the control unit changes the method of the automatic movement control to the method in which the number of the user's tasks is smaller than the current method of the automatic movement control after the control unit changes the methods of the communication entailed by the increase in the quality of the communication.
